(19) United States
(12) Patent Application Publication
(10) Pub. No.: US 2021/0274722 A1
(43) Pub. Date: Sep. 9, 2021

(54) GROW LIGHT SYSTEM

(71) Applicant: Barron Lighting Group, Glendale, AZ (US)

(72) Inventor: Alan Tracy, Phoenix, AZ (US)

(21) Appl. No.: 17/177,143

(22) Filed: Feb. 16, 2021

Related U.S. Application Data
(60) Provisional application No. 62/976,674, filed on Feb. 14, 2020.

(51) Int. Cl. A01G 7/04; F21V 21/096; F21V 23/06; F21V 21/008

(52) U.S. Cl. CPC A01G 7/045; F21V 21/096; F21Y 2115/10; F21V 21/008; F21V 23/06

(57) ABSTRACT

Disclosed is a grow light system of any of a variety of modular LED light bars. The light bars may emit light that is heavily-weighted in a red wavelength spectrum, particularly suited for fruiting and flowering growth stages of growing plants, or heavily-weighted in a blue wavelength spectrum, particularly suited for beginning growth stages of growing plants, or in a full wavelength spectrum more closely approximating white light, particularly suited for all cycles of plant life, or any of a variety of other useful light output spectra, or combinations thereof. The light bars may be stand-alone components or combined in a modular fashion. The system may also include a green LED exit sign and/or luminaire emitting light in a limited green wavelength spectrum, providing illumination while not adversely affecting plant growth during dark cycles. The light bars may be suspended from an adjustable rectangular frame.

### BACKGROUND OF THE INVENTION

### Technical Field

This invention relates generally to grow lights, and particularly to a customizable system of LED grow lights that produces optimal light spectrum signatures for a variety of specific applications.

### State of the Art

Grow lights are artificial light sources for stimulating plant growth, typically in applications where there is no naturally occurring light, or where supplemental light is required, such as in indoor applications. Grow lights are used for horticulture, indoor gardening, plant propagation and food production, including indoor hydroponics and aquatic plants. Specific ranges of light spectrum, luminous efficacy and color temperature are desirable for use with specific plants and time periods. In recent years, use of LED (light-emitting diode) grow lights has been increasing due to their high efficiency, ability to produce specific wavelength spectra of light, and continuing decrease in cost.

Conventional LED grow lights may be configured, for example, as an array of LEDs on a support structure, collectively known as a light bar, wherein the light bar may be integral to or a component of a luminaire. However, particular grow lights may be limited to a particular spectrum that is not most desirable for a particular application. In addition, many LED light bars are not interchangeable with various light fixtures and/or frame structures.

Short-day plants are plants that require a period of at least 12 hours of darkness (a photoperiod that has an absence of light in active growth wavelengths) in order to induce and maintain proper flowering/fruiting growth stages. Conventional lighting, such as task lighting and/or emergency/egress lighting, and the like, used for indoor plant growing rooms and other horticultural applications, include light in active growth wavelengths that adversely affect the growth stages of plants.

Accordingly, what is needed is an improved grow light system that is cost-effective, efficient, and that may produce any of a variety of desirable light spectrum signatures in a customizable way.

### SUMMARY OF THE INVENTION

The present invention relates to lighting, and particularly to a customizable system of LED grow lights that produces optimal light spectrum signatures for a variety of specific applications, and that avoid providing undesirable light in active growth wavelengths at undesirable times.

A light bar may comprise an array of LEDs coupled to a support structure, a driver coupled to, or integral to, the support structure and in electrical communication with each LED of the array of LEDs, and a power cord coupled thereto for supplying power to the driver by connection to an external power source. A support structure may comprise a plurality of mounting holes, mounting slots, mounting brackets, mounting accessories, and/or any combination thereof (not shown), for coupling the support structure to any of a variety of standard lighting system components, such as conventional light fixture components, frame structures, rack systems, and the like, in an interchangeable modular fashion. A light bar may comprise at least one magnet coupled thereto for magnetically coupling the light bar to any of a variety of ferrous components of a light fixture, frame structure, or the like, to which it may be attached.

A first embodiment of a light bar may emit light in a wavelength spectrum that is heavily-weighted in a red wavelength spectrum, particularly suited for fruiting and flowering growth stages of growing plants. For example, the red wavelength spectrum may be in the range of approximately 590 nm to 860 nm. A second embodiment of a light bar may emit light in a wavelength spectrum that is heavily-weighted in a blue wavelength spectrum, particularly suited for beginning growth stages of growing plants. For example, the blue wavelength spectrum may be in the range of approximately 400 nm to 520 nm. A third embodiment of a light bar may emit light in a full wavelength spectrum more closely approximating white light, particularly suited for all cycles of plant life. For example, the white wavelength spectrum may be in the color temperature range of approximately 2500K to 6700K. In addition the spectral output of a light bar may include any of a variety of other useful light output spectra, or combinations thereof. For example, a light bar may emit light in a wavelength spectrum that is limited to a green wavelength range that is safe for exposure to growing plants during “dark” photoperiods (emulating nighttime). The green wavelength spectrum may be in the range of about 528 nm to 540 nm. Other embodiments of a light bar may emit ultraviolet light in a first ultraviolet range of about 315 nm to 400 nm, or in a second ultraviolet range of about 280 nm to 315 nm.

In some embodiments, a light bar may comprise LEDs of various wavelength spectra in any combination with LEDs of other wavelength spectra to create a custom light spectrum signature to address specific lighting needs. In addition, light bars, of the present invention, may be stand-alone components, or they may be combined together in various locations, numbers, and/or configurations, in a modular fashion, to create a custom light spectrum signature to address specific lighting needs.

A green LED exit sign, according to an embodiment, emits light in a limited green wavelength spectrum, providing visibility and a safe means of egress from a structure in which the LED exit sign is located, while not adversely affecting plant growth during dark cycles. Similarly, a green light LED luminaire, according to an embodiment, comprises an LED light bar that emits light in a limited green wavelength spectrum that does not adversely affect plant growth during growth cycles.

Because a green LED exit sign and a green light LED luminaire, as described above, emit light in a limited green wavelength spectrum, such components may be utilized in applications in which light of other wavelengths may adversely affect plant growth during dark cycles. Thus, for example, critical tasks to be performed in grow rooms (such as plant grooming, maintenance, and the like), as well as safe egress from rooms, may be performed under green light illumination during dark cycles without adversely affecting plant growth.

A grow light frame assembly may comprise a framework (such as, for example, a rectangular framework) that may be suspended from or otherwise coupled to a support structure. A grow light bar, or bars, may be suspended or otherwise coupled to the modular grow light frame, in any combination.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in conjunction with the Figures, wherein like reference numbers refer to similar items throughout the Figures, and:

FIG. 1 illustrates a red spectrum LED linear grow light, of a grow light system, suited for flowering cycles of growing plants, according to an embodiment;

FIG. 2 illustrates a blue spectrum LED linear grow light, of a grow light system, suited for vegetative and mother juvenile or leafy growing plants, according to an embodiment;

FIG. 3 illustrates a full spectrum LED linear grow light, of a grow light system, suited for all cycles of plant life, according to an embodiment;

FIG. 4 illustrates a set of one each of red, blue, and full spectrum LED linear grow lights, of a grow light system, according to an embodiment;

FIG. 5 illustrates a set of one each of red, blue, and full spectrum LED linear grow lights, of a grow light system, according to an embodiment;

FIG. 6 is a close-up view of a red spectrum LED linear grow light, of a grow light system, according to an embodiment;

FIG. 7 is an exploded view of an LED linear grow light mounted to a pair of ferrous surfaces by magnets, according to an embodiment;

FIG. 8 is an exploded view of an LED linear grow light mounted to a surface by mounting hardware, according to an embodiment;

FIG. 9A illustrates a green LED exit sign emitting light in a limited green wavelength spectrum, according to an embodiment;

FIG. 9B illustrates additional features of the green LED exit sign of FIG. 9A;

FIG. 10 illustrates a green LED luminaire emitting light in a limited green wavelength spectrum, according to an embodiment;

FIG. 11 is a perspective view of a modular light bar rack, according to an embodiment;

FIG. 12 illustrates perspective and end views of a rail of a modular light bar rack, according to an embodiment;

FIG. 13A illustrates a top view, side view, and corner detail of a grow light frame assembly, according to an embodiment;

FIG. 13B is an exploded perspective view of a grow light frame assembly, according to the embodiment of FIG. 13A;

FIG. 15A is a perspective view of a grow light frame assembly, according to an embodiment;

FIG. 15B illustrates top and side views of strut channel rails of a grow light frame assembly, according to the embodiment of FIG. 15A;

### DETAILED DESCRIPTION OF EMBODIMENTS OF THE INVENTION

As discussed above, embodiments of the present invention relate to lighting, including grow lights, and to a customizable system of LED grow lights that produces optimal light spectrum signatures for a variety of specific applications, and emergency exit signs that avoid providing undesirable light in active growth wavelengths at undesirable times

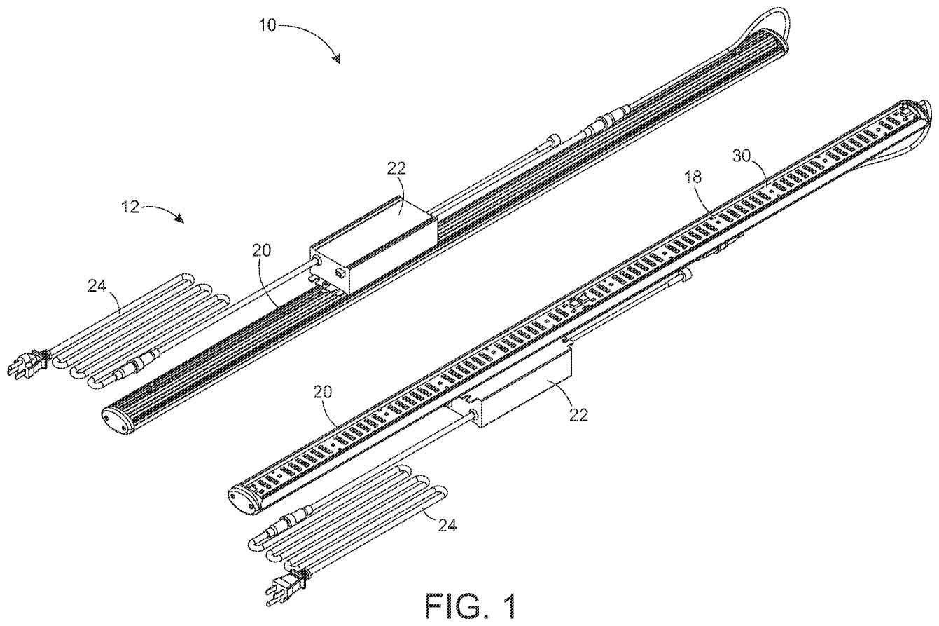

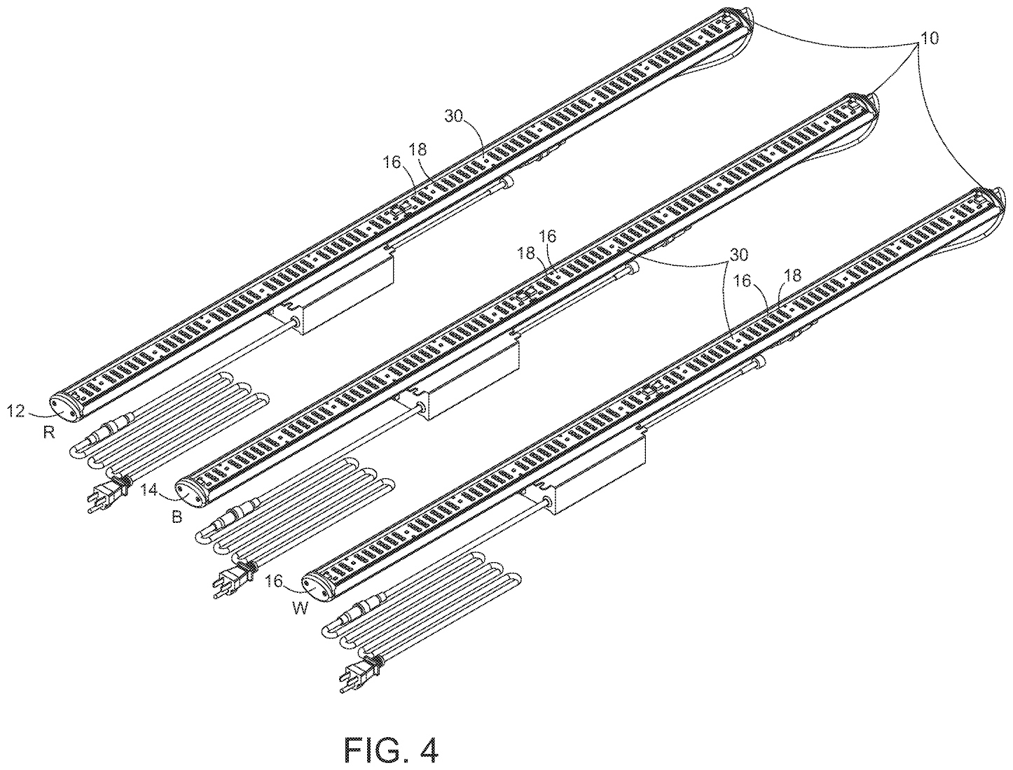

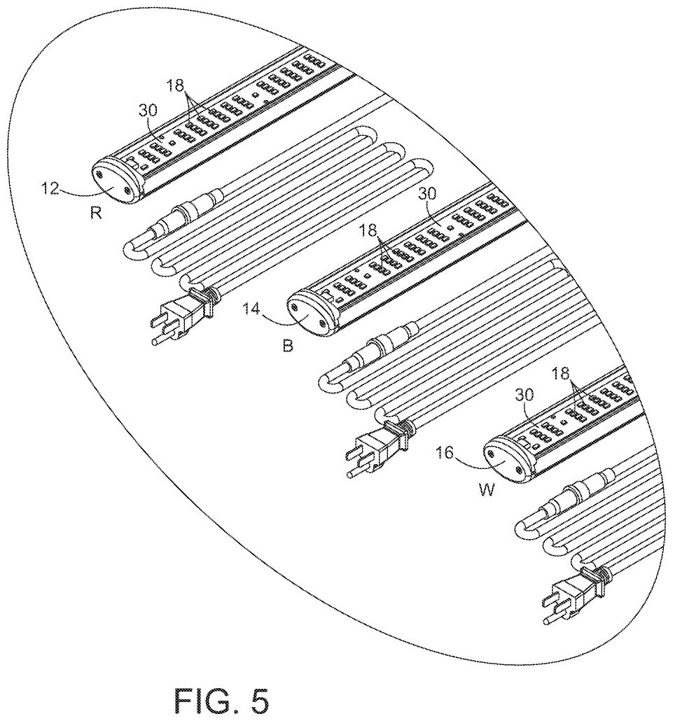

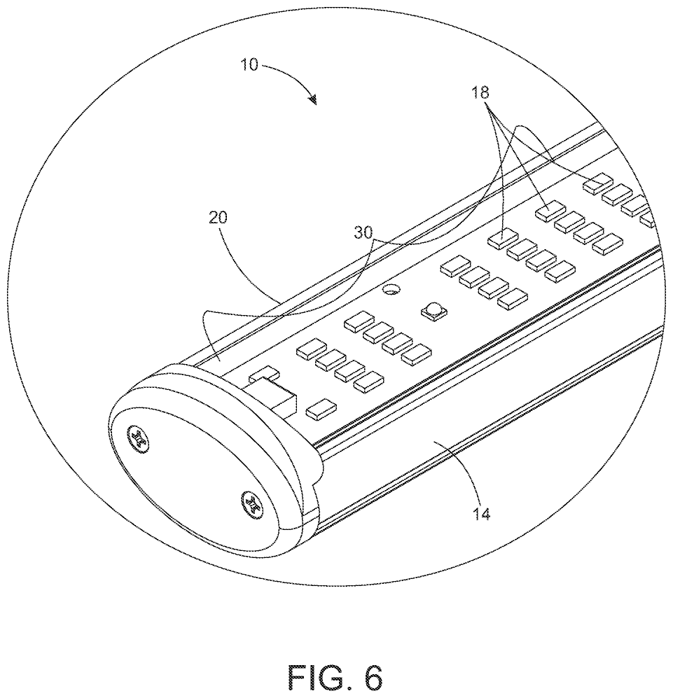

Referring to the drawings, FIGS. 1-8 illustrate exemplary embodiments of a light bar 10 of a grow light system 8 of the present invention. As shown, a light bar 10 may comprise an array 30 of LEDs 18 coupled to a support structure 20. A light bar 10 may be elongate, and composed of extruded aluminum, as shown in the drawings, but this is not intended to be limiting. A light bar 10 may be of any other suitable shape, such as circular, oval, rectangular, or the like, and may be composed of any other suitable material. A light bar 10 may further comprise a driver 22 coupled to, or integral to, the support structure 20, and in electrical communication with each LED 18 of the array 30 of LEDs 18, as well as a power cord 24 coupled thereto for supplying power to the driver 22 by connection to an external power source. In a preferred embodiment, the driver 22 is integral to an elongated support 20 structure composed of extruded aluminum. The driver 22 may be, for example, an electronic driver that allows the intensity of the LEDs to be dimmed from full intensity to off.

A support structure 20 may comprise a plurality of mounting holes, mounting slots, mounting brackets, mounting accessories, and/or any combination thereof (not shown), for coupling the support structure to any of a variety of standard lighting system components, such as conventional light fixture components, frame structures, rack systems, and the like. Thus, a light bar 10, or a plurality of light bars 10, of the present invention, may be easily and independently replaceable and interchangeable with other standard lighting system components, conventional light fixture components, frame structures, rack systems, and the like, without the need to replace, or purchase for replacement, entire luminaires, frame structures, rack systems, or light fixture systems.

A light bar 10 may comprise at least one magnet 26 coupled thereto for magnetically coupling the light bar 10 to any of a variety of ferrous components 28 of a light fixture, frame structure, or the like, to which it may be attached.

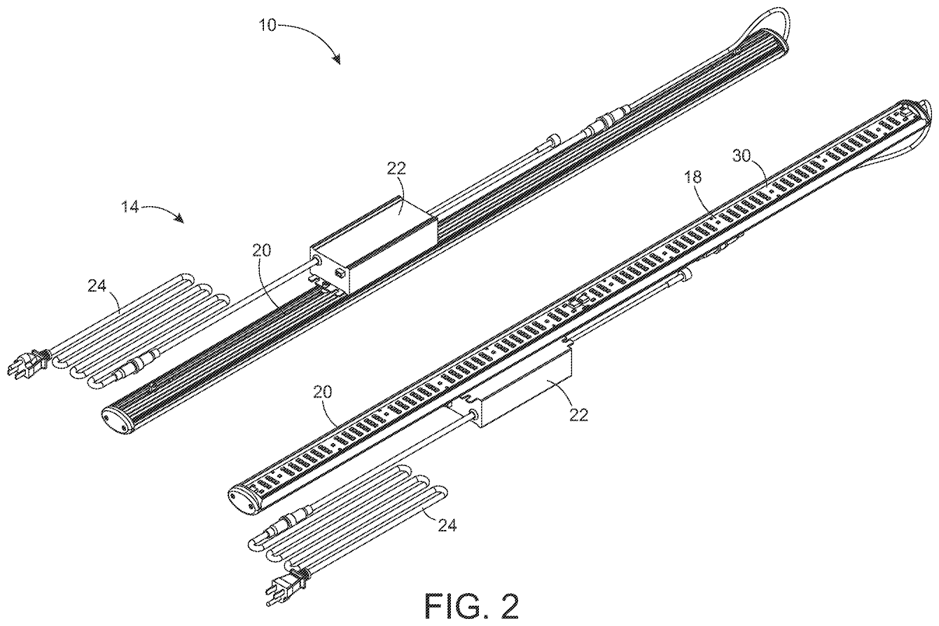

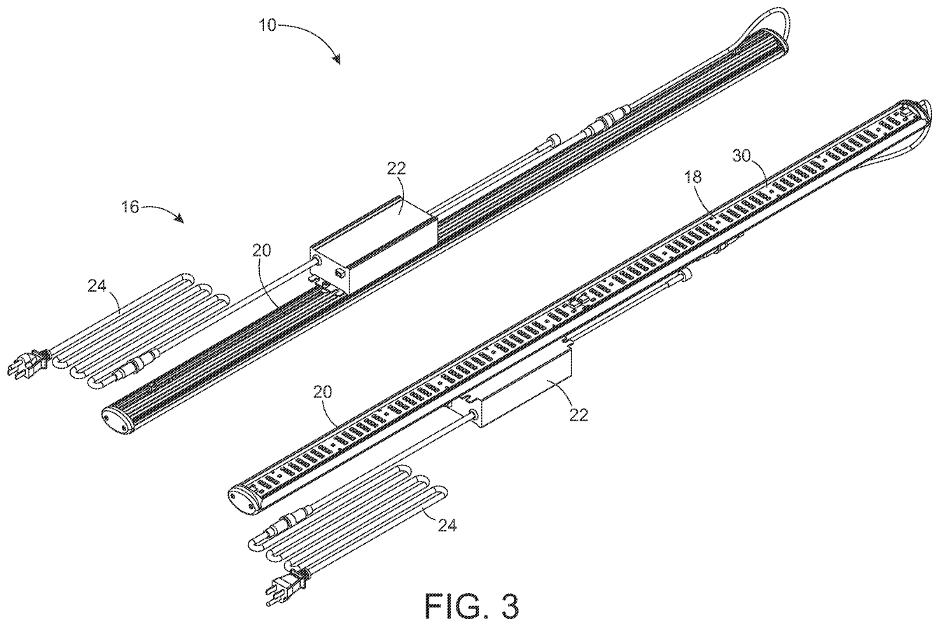

A first embodiment of a light bar 12, as shown in FIG. 1, may emit light in a wavelength spectrum that is heavily-weighted in a red wavelength spectrum. The red-dominant spectrum is particularly suited for fruiting and flowering growth stages of growing plants. In an embodiment, this wavelength spectrum may be in the range of about 590 nm to 860 nm (“Red” light). A second embodiment of a light bar 14, as shown in FIG. 2, may emit light in a wavelength spectrum that is heavily-weighted in a blue wavelength spectrum. The blue-dominant spectrum is particularly suited for beginning growth stages of growing plants. In an embodiment, this wavelength spectrum may be in the range of about 400 nm to 520 nm (“Blue” light). A third embodiment of a light bar 16, as shown in FIG. 3, may emit light in a full wavelength spectrum more closely approximating white light. The white light full spectrum is particularly suited for all cycles of plant life. In an embodiment, this may be in the color temperature range of about 2500K to 6700K (“White” light). The spectral output of a light bar 10 of the present invention is not limited to those of the three embodiments 12, 14, and 16 illustrated in FIGS. 1-3, but may include any of a variety of other useful light output spectra, or combinations thereof. For example, it is contemplated that a light bar 10 may emit light in a wavelength spectrum that is limited to a green wavelength range of about 528 nm to 540 nm (“Green” light). A green spectral output is safe for exposure to growing plants during “dark” photoperiods (emulating nighttime) because the green light does not adversely affect plant growth, as does light of other wavelengths, such as red and blue, during “dark” photoperiods. In another embodiment, a light bar 10 may emit light in a wavelength spectrum in a first ultraviolet range of about 315 nm to 400 nm (“First UV” light). In yet another embodiment, a light bar 10 may emit light in a wavelength spectrum in a second ultraviolet range of about 280 nm to 315 nm (“Second UV” light). In other embodiments, a light bar 10 may emit light in any other wavelength spectrum range.

In some embodiments, a lightbar 10 may comprise a plurality of LEDs 18 coupled thereto, wherein each of the plurality of LEDs 18 may emit light in a Red, Blue, White, First UV, or Second UV light range, in any combination with other of the plurality of LEDs 18 in any other of Red, Blue, White, First UV or Second UV light range. For example, without limitation, a lightbar 10 may comprise an array 30 of LEDs 18, wherein 10% of the array of LEDs is Blue, 35% is Red, 35% is White, 10% is of the First UV range, and 10% is of the Second UV range. By combining various numbers of LEDs 18 of different colors on a single light bar 10, including Blue, Red, White, First UV, and Second UV ranges, a customized combined spectral light output may be achieved that has desired characteristics for specific growing conditions or other lighting needs. Each of a variety of Red, Blue, White, First UV, or Second UV range LEDs may be combined in any number from 0% to 100%, in any combination, as a specialized “Recipe” to provide a particular spectral light output corresponding to that Recipe.

Light bars 10 of the present invention may be stand-alone components, or they may be combined together by a purchaser to provide any of an infinite number of desirable light spectrum signatures. For example, light bars 10 may be combined in various locations, numbers, and/or configurations, in a modular fashion, according to a particular Recipe to create a custom light spectrum signature to address specific lighting needs. In some embodiments, multiple light bars 10 may be electrically-connected in a daisy-chain fashion. Because the light bars 10 are modular, they may be arranged, rearranged, added, deleted, exchanged, or replaced, in any combination, without the need to purchase or replace entire light bar systems, entire fixtures, frame structures, rack systems, and the like.

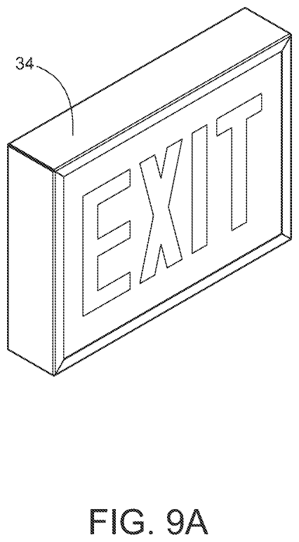

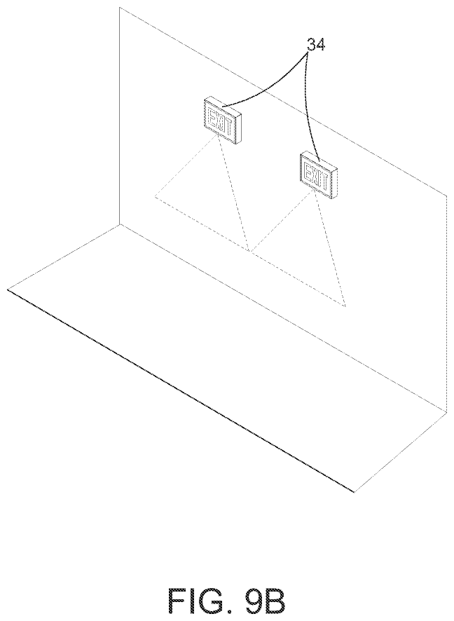

As described briefly above, short-day plants require a period of at least 12 hours of darkness (a photoperiod that has an absence of light in active growth wavelengths) in order to induce and maintain proper flowering/fruiting growth stages. Conventional lighting, such as task lighting and/or emergency/egress lighting, and the like, used for indoor plant growing rooms and other horticultural applications, includes light in active growth wavelengths (such as light in the blue and red spectral ranges) that adversely affect the growth stages of plants. Referring again to the drawings, FIGS. 9A and 9B illustrate a green LED exit sign 34 emitting light only in a limited green wavelength spectrum, according to an embodiment. Such a plant-safe, green light provides a safe means of egress (by providing visibility in an otherwise dark location) while not adversely affecting plant growth during dark cycles. This is because, as described above, light in the limited green wavelength spectrum, such as that emitted by a green LED exit sign 34 disclosed herein, does not adversely affect plant growth during dark cycles.

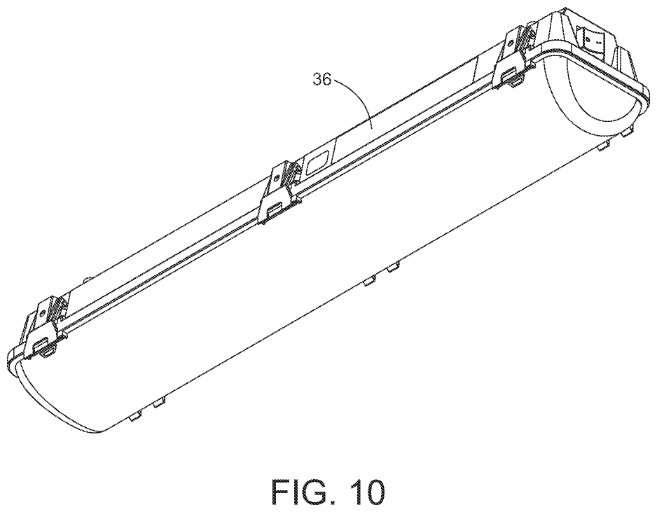

Similarly, referring to FIG. 10, a green light LED luminaire 36 of the present invention comprises an LED light bar that emits light only in a limited green wavelength spectrum. Light in the blue and red spectral ranges has been effectively eliminated from the light output from a green light LED luminaire 36, as disclosed.

Because a green LED exit sign 34 and a green light LED luminaire 36, as described above, emit light only in a limited green wavelength spectrum, such components may be utilized in applications in which light of other wavelengths may adversely affect plant growth during dark cycles. Thus, for example, critical tasks to be performed in grow rooms (such as, for example, plant grooming or maintenance tasks preformed at night), as well as safe egress, may be performed under green light illumination during dark cycles without adversely affecting plant growth.

Some embodiments of a green light LED luminaire 36, and/or a green LED exit sign 34, may comprise a battery backup (not shown) to allow for continuous operation during power outages.

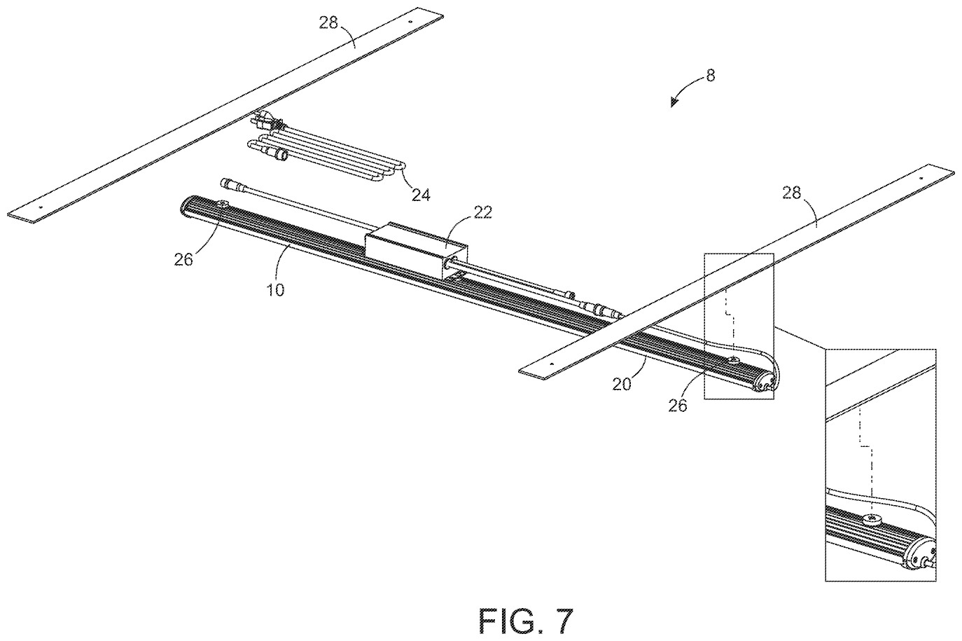

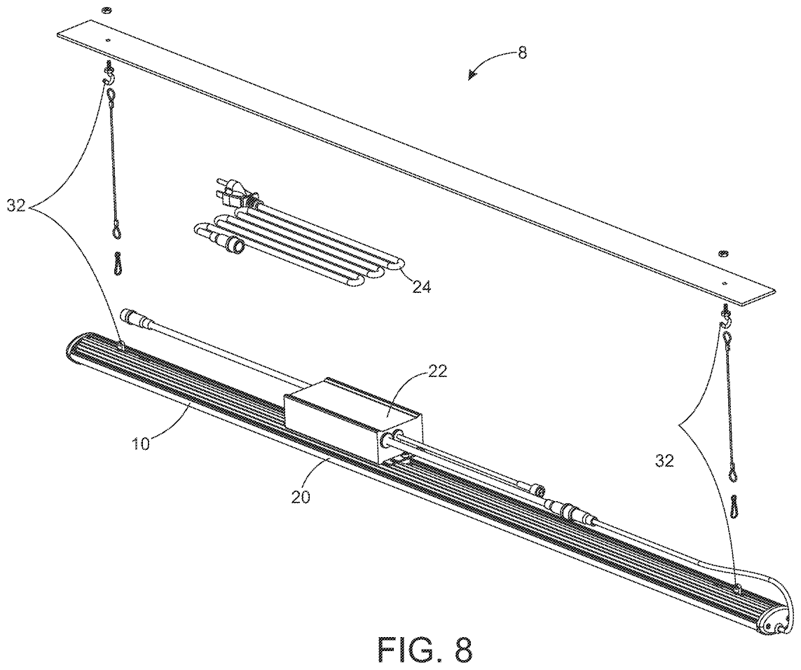

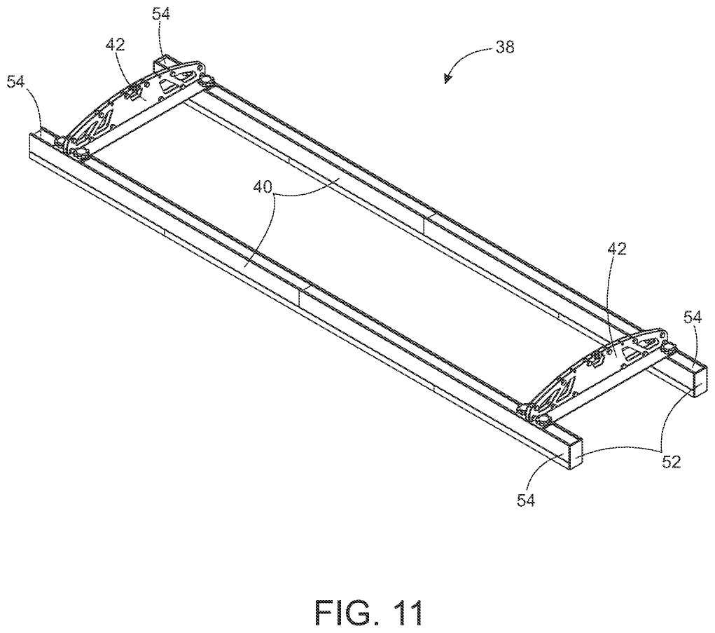

Referring to FIG. 11, a modular grow light frame 38 may comprise a pair of parallel side rails 40 and a pair of parallel cross members 42 coupled together to form a rectangular frame 38, for suspending at least one grow light bar 10, as described above. Light bars 10, in any suitable number and/or configuration may be suspended from the modular grow light frame 38 by any suitable means, such as by magnets 26, sliding mounting brackets or other mounting hardware 32, and the like, as shown in FIGS. 7 and 8, for example. In some embodiments, as shown in FIG. 7, each of the at least one grow light bar 10 may comprise at least one magnet 26 coupled thereto for magnetically suspending the light bar 10 from a grow light frame directly, wherein the grow light frame is composed of a ferrous material, or from a ferrous mounting member 28 coupled to the grow light frame 38, wherein the grow light frame 38 is composed of a nonferrous material. In other embodiments, as shown in FIG. 8, each of the at least one grow light bar 10 may be suspended from a mounting frame of any suitable ferrous or non-ferrous material by use of mounting and/or hanging hardware 32.

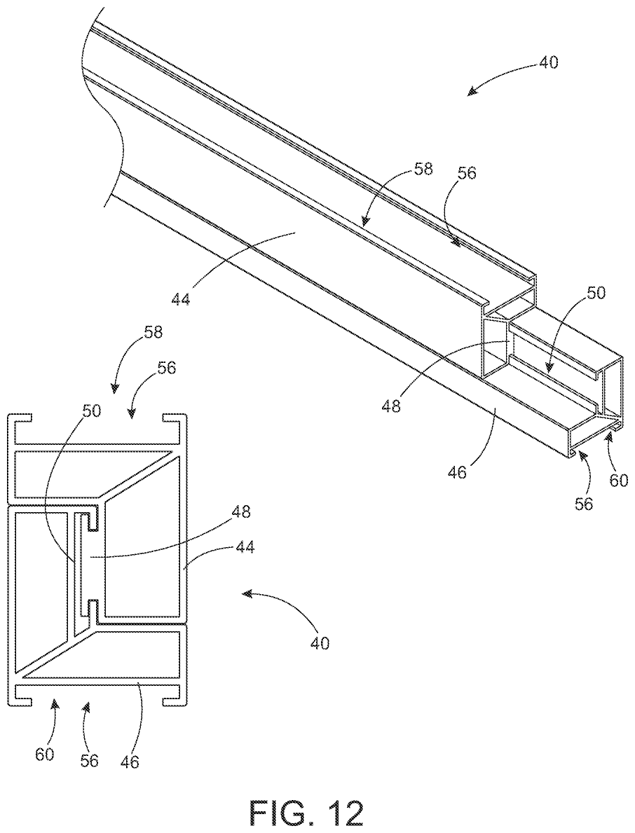

As shown in FIG. 12, each of the pair of side rails 40 of a grow light frame 38 may comprise a first rail member 44 and a second rail member 46 slidingly coupled together, wherein the first rail member 44 may slide relative to the second rail member 46 to adjust the overall length of the side rail 40. As shown in FIG. 12, a first rail member 44 may comprise a tee slide member 48 configured to engage a tee slide channel 50 of the second rail member 46, whereby the first rail member 44 may slide in a longitudinal direction relative to the second rail member 46. However, this is not intended to be limiting. It is understood that any of a variety of configurations may be suitable for allowing a first rail member 44 to slidingly engage a second rail member 46 without departing from the spirit of this teaching.

Also, as shown in FIG. 12, each of the pair of side rails 40 may comprise at least one mounting bracket channel 56. For example, each of the pair of side rails 40 may comprise a top mounting bracket channel 58 and a bottom mounting bracket channel 60, as shown in FIG. 12. A mounting bracket channel 56 may be configured for coupling a cross member 42 thereto. For example, a mounting bracket channel 56 may be a tee slot 62, as shown in FIGS. 20A through 20J. In the embodiment shown, a steel plate 64 is inserted into the mounting bracket channel 62, the steel plate 64 having at least one threaded aperture 66 therethrough for receiving a mounting bolt 68. A cross member 40 is coupled to the steel plate 64 by the at least one mounting bolt 68. In this embodiment, when the mounting bolt 68 is loose, the steel plate 64 may slide in the mounting bracket channel 62 to adjust the position of the steel plate 64 relative to the side rail 40. When the mounting bolt 68 is tightened, the steel plate 64 is securely fixed to the side rail 40. Furthermore, the embodiment shown comprises at least two mounting bolts 68 coupled to each steel plate 64 at the ends of each cross member 42, respectively, thereby maintaining each cross member 42 perpendicular to each side rail 40, thereby maintaining the rectangular frame configuration. Some embodiments may further comprise a spring 74 coupled between the steel plate 64 and the side rail 40 for maintaining friction between the steel plate 64 and the side rail 40 for maintaining the steel plate 64 in position relative to the side rail 40 in response to the force of the spring 74 acting on the steel plate 64 and the side rail 40. The friction may be overcome by pressing the steel plate 64 to compress the spring 74 and sliding the steel plate 64 and spring 74 relative to the side rail 40.

Each end 54 of each side rail 40 may comprise an end cap 52 coupled thereto, as shown in FIG. 11. An end cap 52 may be coupled to the side rail 40 by any suitable means, such as by use of screws and/or bolts, or by friction fit, as shown.

A modular grow light frame 40, as shown in FIG. 11 may be of any length and width. Frame size may be changed by adjusting the coupling locations of each cross member 42 to the side rails 40. In addition, the lengths of each of the side rails 40 may be adjusted by sliding the first rail members 44 thereof relative to the second rail members 46 thereof. The width of a modular grow light frame 38 may be changed by use of cross members 42 of different lengths. A modular grow light frame 38 may be configured to be suspended from or otherwise coupled to a support structure (not shown), and at least one grow light bar 10 may be suspended or otherwise coupled to the modular grow light frame 38, in any combination, as described above. A modular grow light frame 38 of the embodiment shown is particularly suited for efficient assembly for packing and shipping. Multiple modular grow light frames 38 may be efficiently packaged together for shipping.

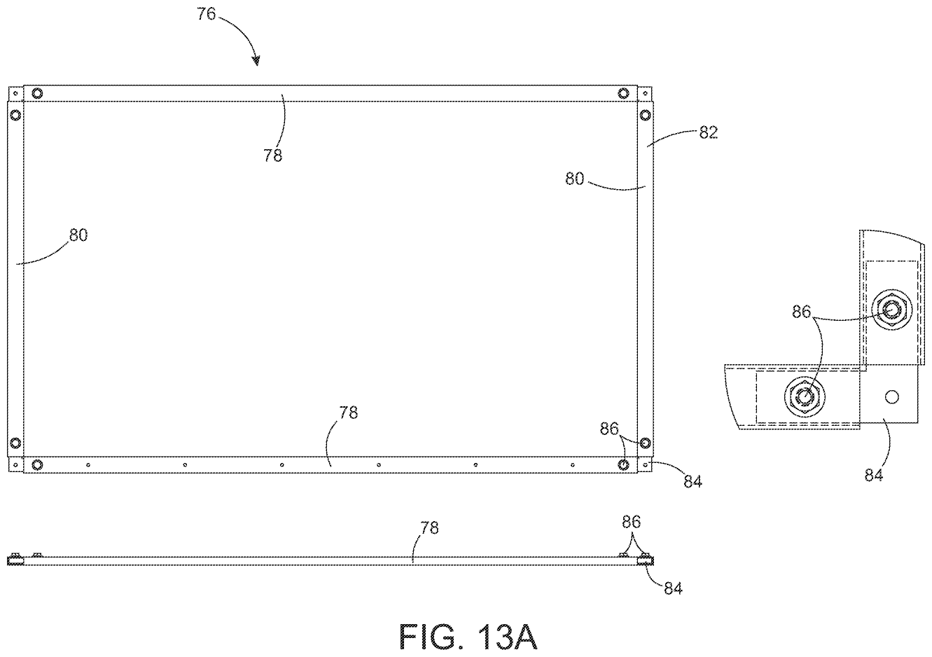

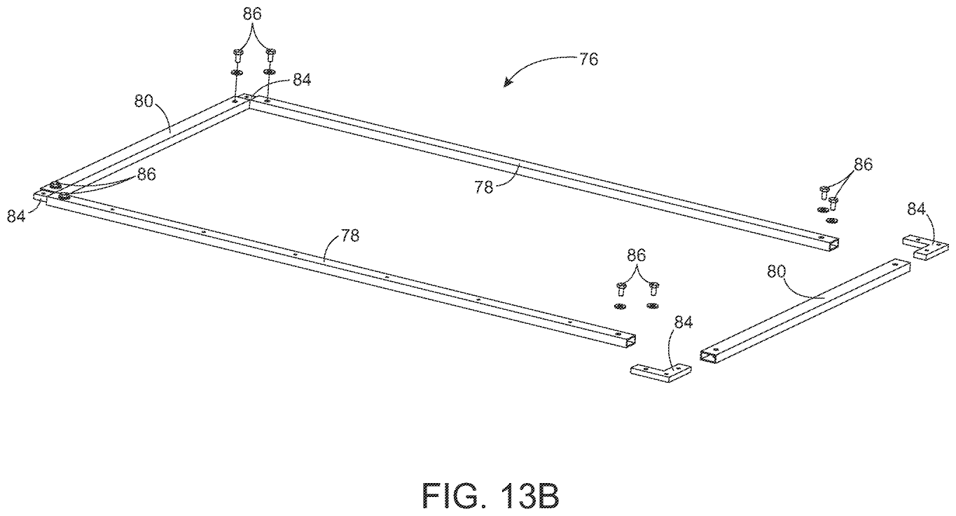

As shown in FIGS. 13A and 13B, a grow light frame assembly 76 may comprise a pair of parallel side rails 78 and a pair of parallel end rails 80 coupled together to form a rectangular frame 82. The frame 82 may be of any length and any width corresponding to the lengths of the pair of side rails 78 and the lengths of the pair of end rails 80, respectively. In the embodiment shown, each of the side and end rails 78 and 80 is of tubular stock, such as rectangular steel tubing, or other suitable stock. As shown, each side rail 78 may be coupled to each end rail 80 by a corner coupler 84, wherein the corner coupler 84 is an L-shaped member, the legs of which are configured for insertion into the ends of the corresponding side and end rails 78 and 80, respectively, and bolted thereto by a pair of bolts 86. A corner coupler assembly 90 is shown in detail in FIG. 13A. A grow light frame assembly 76, of the embodiment shown in FIGS. 13A and 13B, may be used in a similar manner as the embodiment shown in FIG. 11, wherein the frame assembly 76 may be suspended from or otherwise coupled to a support structure, and at least one grow light bar 10 may be suspended or otherwise coupled to the modular grow light frame 82, in any combination, as described above.

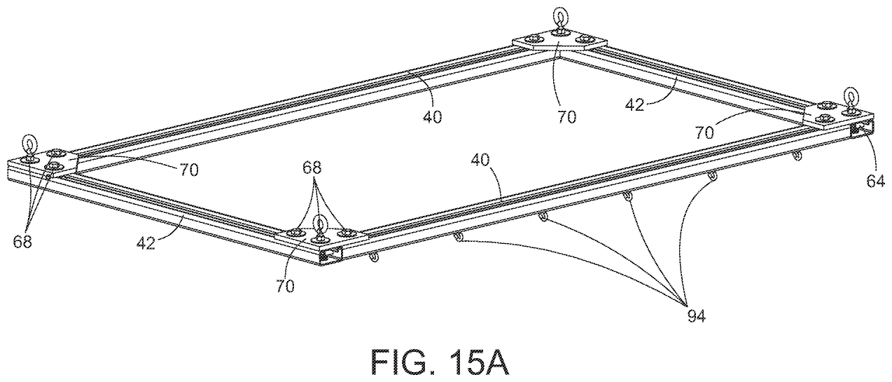

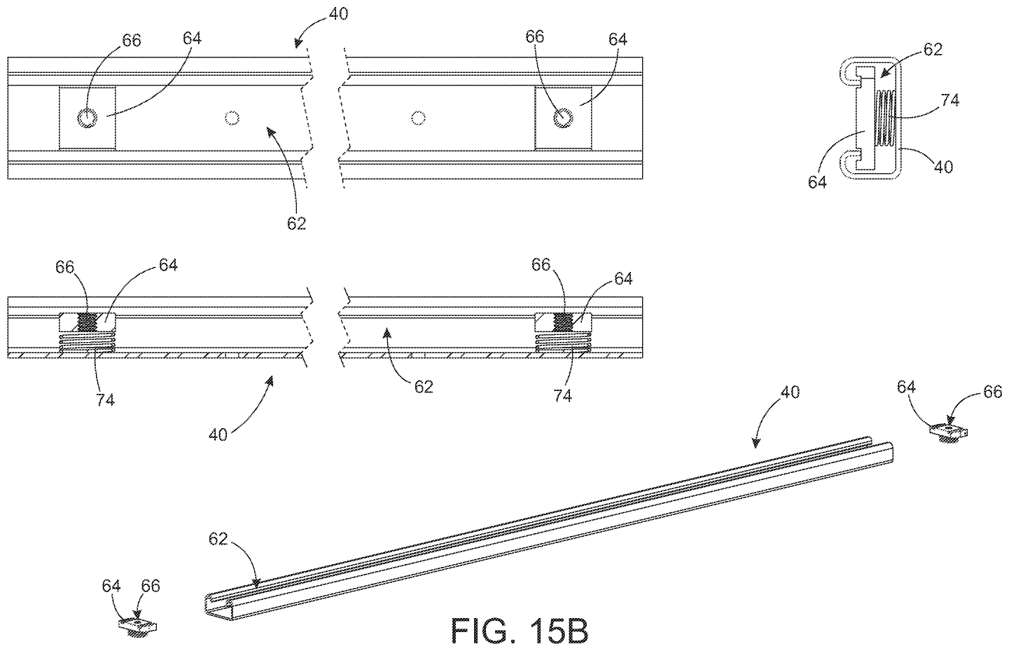

A grow light frame assembly 76 may comprise a pair of parallel side rails 40 and a pair of parallel end rails 42 coupled together to form a rectangular frame 82. The frame 82 may be of any length and any width corresponding to the lengths of the pair of side rails 40 and the lengths of the pair of end rails 42, respectively. In the embodiment shown, each of the side and end rails 40 and 42 is of common steel channel strut. As shown, each side rail 40 may be coupled to each end rail 42 by a corner bracket 70, wherein the corner bracket 70 is configured for coupling to the ends of the corresponding side and end rails 40 and 42, respectively, and bolted thereto by use of bolts 68 and receiving nuts 64. In the embodiment shown, a receiving nut 64 may be spring-loaded for fitting within a channel 62 of the channel strut side and end rails 40 and 42. The spring 74 biases the receiving nut 64 against the channel strut arms but may be overcome by pressing the receiving nut 64 inward, thereby allowing the receiving nut 64 and spring 74 to slide within the channel 62 for adjusting the location of the receiving nut 64 relative to the channel 62. In the embodiment shown, one of the side rail 40 or end rail 42, at a corner junction, may comprise a single receiving nut 64, and the other of the side rail 40 or end rail 42 may comprise two receiving nuts 64, one of the two receiving nuts 64 being located at the corner where the two rails intersect. A mounting bolt 68 is inserted through the corner bracket 70 and into each receiving nut 64 to secure the corner bracket 64 to the rail and fix the receiving nut 64 to the rail. When the mounting bolts 68 are loosened, the corresponding receiving nuts 64 and springs 74 are free to slide within the channel 62 of the rail to adjust the location of the corner bracket 70, but only in the rail comprising the receiving nut 64 located at the corner where the two rails 40 and 42 intersect. In this manner, the width of the frame assembly 76 may be adjusted by changing the positions of the corner brackets 70 relative to the end rails 42. Similarly, by changing the interfaces between the side rails 40 and end rails 42, such that the end rails 42 run into the ends of the side rails 40, the length of the frame assembly 76 may be adjusted by changing the positions of the corner brackets 70 relative to the side rails 40. One or more of the mounting bolts 68 may be an eyebolt configured for suspending the frame assembly 76 from a support structure. Furthermore, a frame assembly 76 may comprise at least one hook 94 coupled thereto for suspending one or more light bars 10 from the frame assembly 76 in the manner shown in FIG. 8. A grow light frame assembly 76, may be used in a similar manner as the embodiments shown in FIGS. 11-18, and 13A-13B, wherein the frame assembly 76 may be suspended from or otherwise coupled to a support structure, and at least one grow light bar 10 may be suspended or otherwise coupled to the modular grow light frame 38, in any combination, as described above.

The components defining any grow light system may be formed of any of many different types of materials or combinations thereof that can readily be formed into shaped objects provided that the components selected are consistent with the intended operation of a grow light system. For example, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as copper, zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining any grow light system may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, sewing, any combination thereof, and/or the like for example, depending on, among other considerations, the particular material forming the components. Other possible steps might include sand blasting, polishing, powder coating, zinc plating, anodizing, hard anodizing, and/or painting the components for example.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A grow light system, comprising:
a light bar, comprising:
a support structure; and
an array of LEDs coupled to the support structure;
a driver coupled to the support structure and in electrical communication with each LED of the array of LEDs; and
a power cord coupled to the driver.

2. The grow light system of claim 1, wherein each LED of the array of LEDs is selected from the group of LEDs consisting of: LEDs emitting light in a red-dominant wavelength spectrum of about 590 nm to 860 nm, LEDs emitting light in a blue-dominant wavelength spectrum of about 400 nm to 520 nm, LEDs emitting light in a white light full spectrum in the color temperature range of about 2500K to 6700K, and any combination thereof.

3. The grow light system of claim 1, wherein each LED of the array of LEDs is selected from the group of LEDs consisting of: LEDs emitting light in a red-dominant wavelength spectrum of about 590 nm to 860 nm, LEDs emitting light in a blue-dominant wavelength spectrum of about 400 nm to 520 nm, LEDs emitting light in a white light full spectrum in the color temperature range of about 2500K to 6700K, LEDs emitting light in a green-dominant wavelength spectrum of about 528 nm to 540 nm, LEDs emitting light in a first ultraviolet wavelength spectrum range of about 315 nm to 400 nm, LEDs emitting light in a second ultraviolet wavelength spectrum range of about 280 nm to 315 nm, and any combination thereof.

4. The grow light system of claim 1, wherein a first portion of the array of LEDs emits light in a red-dominant wavelength spectrum of about 590 nm to 860 nm, a second portion of the array of LEDs emits light in a blue-dominant wavelength spectrum of about 400 nm to 520 nm, and a third portion of the array of LEDs emits light in a white light full spectrum in the color temperature range of about 2500K to 6700K.

5. The grow light system of claim 1, wherein a first portion of the array of LEDs emits light in a red-dominant wavelength spectrum of about 590 nm to 860 nm, a second portion of the array of LEDs emits light in a blue-dominant wavelength spectrum of about 400 nm to 520 nm, a third portion of the array of LEDs emits light in a white light full spectrum in the color temperature range of about 2500K to 6700K, a fourth portion of the array of LEDs emits light in a first ultraviolet wavelength spectrum range of about 315 nm to 400 nm, and a fifth portion of the array of LEDs emits light in a second ultraviolet wavelength spectrum range of about 280 nm to 315 nm.

6. A modular grow light frame, comprising:
a first side rail;
a second side rail disposed parallel to the first side rail;
a first cross member coupled between and perpendicular to the first side rail and the second side rail; and
a second cross member coupled between and perpendicular to the first side rail and the second side rail and parallel to the first cross member, wherein the frame is configured to receive at least one light bar coupled thereto.

7. The modular grow light frame of claim 6, wherein the frame is configured to receive at least one light bar magnetically coupled thereto.

8. The modular grow light frame of claim 6, further comprising at least one hook configured for suspension of at least one light bar therefrom.

9. The modular grow light frame of claim 6, wherein at least one of the first cross member and the second cross member is slidingly coupled to the first and second side rails, wherein a distance between the first and second cross members is adjustable by sliding the at least one of the first cross member and the second cross member, that is slidingly coupled to the first and second side rails, relative to the first and second side rails.

10. The modular grow light frame of claim 9, wherein the at least one of the first cross member and the second cross member, that is slidingly coupled to the first and second side rails, is slidingly coupled to the first and second side rails by a first mounting bolt threaded into a first spring-loaded channel nut disposed within a first channel in the first side rail and a second mounting bolt threaded into a second spring-loaded channel nut disposed within a second channel in the second side rail, respectively.

11. The modular grow light frame of claim 10, wherein each of the first and second cross members is modularly interchangeable with a first and second cross member of a different length, respectively.

12. A modular grow light system, comprising:
a modular grow light frame, comprising:
a first side rail;
a second side rail disposed parallel to the first side rail;
a first cross member coupled between and perpendicular to the first side rail and the second side rail; and
a second cross member coupled between and perpendicular to the first side rail and the second side rail and parallel to the first cross member;
at least one light bar coupled to the modular grow light frame, each of the at least one light bar comprising:
a support structure; and
an array of LEDs coupled to the support structure;
a driver coupled to the support structure of the at least one light bar and in electrical communication with each LED of the array of LEDs of the at least one light bar; and
a power cord coupled to each driver.

13. The modular grow light system of claim 12, wherein the number of light bars is at least two and each of the at least two light bars is electrically connected with each adjoining light bar in a daisy-chain fashion.

14. The modular grow light system of claim 13, wherein each LED of each array of LEDs is selected from the group of LEDs consisting of: LEDs emitting light in a red-dominant wavelength spectrum of about 590 nm to 860 nm, LEDs emitting light in a blue-dominant wavelength spectrum of about 400 nm to 520 nm, LEDs emitting light in a white light full spectrum in the color temperature range of about 2500K to 6700K, LEDs emitting light in a green-dominant wavelength spectrum of about 528 nm to 540 nm, LEDs emitting light in a first ultraviolet wavelength spectrum range of about 315 nm to 400 nm, and LEDs emitting light in a second ultraviolet wavelength spectrum range of about 280 nm to 315 nm, and any combination thereof.

15. The modular grow light system of claim 14, wherein each of the at least two light bars is magnetically coupled to the modular grow light frame.

16. The modular grow light system of claim 14, wherein each of the at least two light bars is suspended from the modular grow light frame by at least one hook.

17. The modular grow light system of claim 14, wherein at least one of the first cross member and the second cross member of the modular grow light frame is slidingly coupled to the first and second side rails, wherein a distance between the first and second cross members is adjustable by sliding the at least one of the first cross member and the second cross member, that is slidingly coupled to the first and second side rails, relative to the first and second side rails.

18. The modular grow light system of claim 17, wherein the at least one of the first cross member and the second cross member, that is slidingly coupled to the first and second side rails, is slidingly coupled to the first and second side rails by a first mounting bolt threaded into a first spring-loaded channel nut disposed within a first channel in the first side rail and a second mounting bolt threaded into a second spring-loaded channel nut disposed within a second channel in the second side rail, respectively.

19. The modular grow light system of claim 18, wherein each of the first and second cross members is modularly interchangeable with a first and second cross member of a different length, respectively.
